(19) United States
(12) Patent Application Publication
(10) Pub. No.: US 2025/0069348 A1
(43) Pub. Date: Feb. 27, 2025

(54) DATA DISPLAY SYSTEM, DATA DISPLAY APPARATUS, DATA DISPLAY METHOD

(71) Applicant: NEC Corporation, Tokyo (JP)

(72) Inventors: Jiro ABE, Tokyo (JP); Kazumine OGURA, Tokyo (JP)

(73) Assignee: NEC Corporation, Tokyo (JP)

(21) Appl. No.: 18/795,295

(22) Filed: Aug. 6, 2024

(30) Foreign Application Priority Data
Aug. 22, 2023 (JP) 2023-135075

(51) Int. Cl. G06T 19/20; G06T 7/00; G06T 7/70

(52) U.S. Cl. CPC G06T 19/20; G06T 7/0002; G06T 7/70; G06T 2207/30184; G06T 2207/30244; G06T 2219/2012; G06T 2219/2021

(57) ABSTRACT

A data display system includes a photographing position pose estimation means for estimating a photographing position pose of image data in a coordinate system of three-dimensional data, a matter analysis means for detecting a position of a predetermined matter from the image data, and a diagram data display means for displaying a position of the matter on diagram data in a superposed manner, based on the photographing position pose and an analysis result of the matter analysis means.

### INCORPORATION BY REFERENCE

This application is based upon and claims the benefit of priority from Japanese patent application No. 2023-135075, filed on Aug. 22, 2023, the disclosure of which is incorporated herein in its entirety by reference.

### TECHNICAL FIELD

The present disclosure relates to a data display system, a data display apparatus, a data display method, and a program.

### BACKGROUND ART

Patent Literature 1 (Japanese Unexamined Patent Application Publication No. 2020-135450) discloses a data processing apparatus capable of calculating distance data from a camera to a structure and tilt data in a three-dimensional direction of the camera from at least three irradiation points by a laser pointer in detailed image data, integrating a plurality of pieces of partial image data, based on magnification of the partial image data and the detailed image data in each of two wide and narrow image data sets, and acquiring coarse wide-area frontal image data of the structure with a unified scale measure.

### SUMMARY

An example object of the present invention is to provide a technique of displaying, on a diagram, a matter captured in an image.

In a first example aspect of the present disclosure, a data display system includes:
a photographing position pose estimation means for estimating a photographing position pose of image data in a coordinate system of three-dimensional data;
a matter analysis means for detecting a position of a predetermined matter from the image data; and
a diagram data display means for displaying a position of the matter on diagram data in a superposed manner, based on the photographing position pose and an analysis result of the matter analysis means.

In a second example aspect of the present disclosure, a data display apparatus includes:
a photographing position pose estimation means for estimating a photographing position pose of image data in a coordinate system of three-dimensional data;
a matter analysis means for detecting a position of a predetermined matter from the image data; and
a diagram data display means for displaying a position of the matter on diagram data in a superposed manner, based on the photographing position pose and an analysis result of the matter analysis means.

In a third example aspect of the present disclosure, a data display method includes, by a computer:
estimating a photographing position pose of image data in a coordinate system of three-dimensional data;
detecting a position of a predetermined matter from the image data; and
displaying a position of the matter on diagram data in a superposed manner, based on the photographing position pose and an analysis result of the matter analysis means.

In a fourth example aspect of the present disclosure, a program causes a computer to function as:
a photographing position pose estimation means for estimating a photographing position pose of image data in a coordinate system of three-dimensional data;
a matter analysis means for detecting a position of a predetermined matter from the image data; and
a diagram data display means for displaying a position of the matter on diagram data in a superposed manner, based on the photographing position pose and an analysis result of the matter analysis means.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a functional block diagram of a data display system;

FIG. 2 is a functional block diagram of a data display apparatus;

FIG. 3 is a preparation flow before the data display apparatus is used;

FIG. 4 is a photograph of a target object;

FIG. 5 is three-dimensional data relating to the target object;

FIG. 6 is diagram data relating to a member;

FIG. 7 is a projection image of the member;

FIG. 8 is image data;

FIG. 9 is a mask image;

FIG. 10 is a display state of a three-dimensional data display unit;

FIG. 11 is a display state of the three-dimensional data display unit;

FIG. 12 is a member image;

FIG. 13 is a display state of a diagram data display unit;

FIG. 14 is a display state of the diagram data display unit;

FIG. 15 is a processing flow of the data display apparatus;

FIG. 16 is a functional block diagram of a data display apparatus;

FIG. 17 is a preparation flow before the data display apparatus is used;

FIG. 18 is a reference image DB;

FIG. 19 is a display state of the data display apparatus;

FIG. 20 is a processing flow of the data display apparatus;

FIG. 21 is a diagram illustrating a case in which a processing circuit included in the data display apparatus is configured by a processor and a memory; and

FIG. 22 is a diagram illustrating a case in which the processing circuit included in the data display apparatus is configured by dedicated hardware.

### EXAMPLE EMBODIMENT

### (Overview of Present Disclosure)

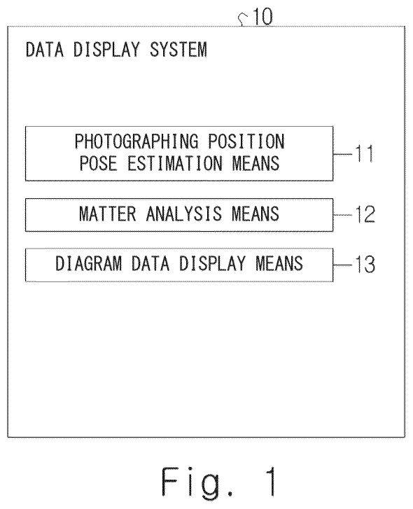

With reference to FIG. 1, an overview of the present disclosure is described below. As illustrated in FIG. 1, a data display system 10 includes a photographing position pose estimation means 11, a photographing position pose estimation means 12, and a diagram data display means 13.

The photographing position pose estimation means 11 estimates a photographing position pose of image data in a coordinate system of three-dimensional data.

The photographing position pose estimation means 12 detects a predetermined matter from the image data.

The diagram data display means 13 displays information relating to the matter being detected by the photographing position pose estimation means 12, based on the photographing position pose being estimated by the photographing position pose estimation means 11.

According to the configuration described above, a matter captured in an image can be displayed on a diagram.

### First Example Embodiment

Next, a first example embodiment of the present disclosure is described with reference to the drawings.

Aging of infrastructure such as a bridge has become a social issue. Thus, in the maintenance and management of infrastructure, safety of infrastructure is assessed by inspecting and recording deformations such as cracks, flaking, exposure of a reinforcing rod, and rust during an inspection, and comparing the number or size of deformations with those in the previous inspection. As of August 2023, in the maintenance and management of a bridge, a periodic inspection is required every five years. In a bridge inspection, an inspection report is prepared and managed as the result of the inspection, the inspection report typically including: a document called a damage diagram in which a position and a size of a deformation generated in each member is recorded on a diagram; and a document called a damage photograph in which photographs capturing deformations are placed.

However, for a business operator that conducts a bridge inspection, recording a deformation state in a damage diagram is not easy. The reason is that, while a bridge in a real work has a three-dimensional structure, a damage diagram has a two-dimensional structure, which makes it difficult to grasp a correlation between a deformation position of a bridge and a deformation position in a diagram. Moreover, many bridge members have symmetric structures, and diagrams thereof, for example, a series of rectangles, lack shape characteristics, which also contributes to the difficulty of grasping positions.

In view of this, the present inventors have developed a technique of automatically recording a damage diagram by taking a photograph capturing a deformation. However, even when automatic recording of a damage diagram by a photograph is achieved, an inspection business operator may need to confirm whether a result of the automatic recording itself is accurate. In such a case, comparison between a position of damage caused to an actual bridge, a damage diagram being automatically recorded, and an inspection photograph is required, and, once again, the difficulty of grasping positions arises.

An object of the present disclosure is to provide a data display system capable of presenting a photographing range of an image in a three-dimensional space and displaying, on a diagram, a matter captured in the image, and to improve efficiency of maintenance and management work by presenting that display on the diagram is accurately operated, as three-dimensional information that is easily-understandable for a user.

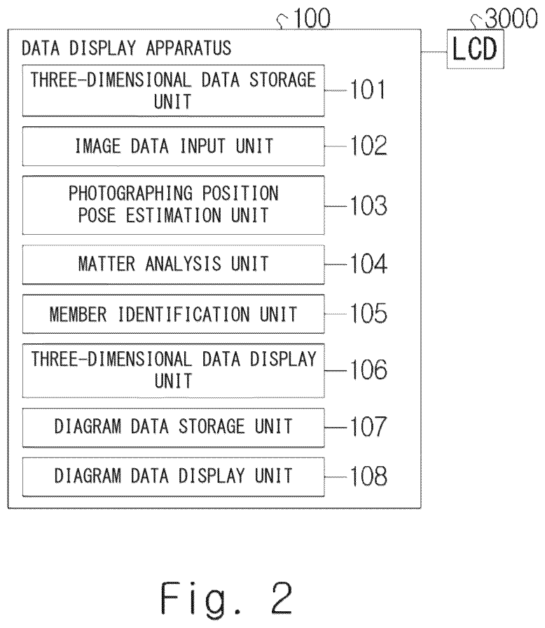

FIG. 2 illustrates a block diagram of a data display apparatus 100. For example, the data display apparatus 100 illustrated in FIG. 2 is used during maintenance and management for a target object in such a way as to achieve efficient maintenance and management for the target object by presenting a photographing range of a photograph, based on the photograph acquired by photographing a predetermined matter occurring to a target object, and recording information relating to the matter on diagram data. The target object is a structure being subjected to maintenance and management work, such as a bridge, a tunnel, and a road. The predetermined matter is a matter that is observed during maintenance and management work for the target object. The predetermined matter is a deformation generated in the target object, such as cracks, flaking, exposure of a reinforcing rod, and rust.

According to FIG. 2, the data display apparatus 100 includes a three-dimensional data storage unit 101, an image data input unit 102, a photographing position pose estimation unit 103, a matter analysis unit 104, a member identification unit 105, a three-dimensional data display unit 106, a diagram data storage unit 107, and a diagram data display unit 108. A liquid crystal display (LCD) 3000 is connected to the data display apparatus 100. The LCD 3000 is one specific example of an output apparatus. The LCD 3000 is one specific example of a display apparatus.

In the present example embodiment, the data display apparatus 100 is achieved by a single apparatus. However, instead, the data display apparatus 100 may be achieved by distributed processing by a plurality of apparatuses.

### (Preparation Flow)

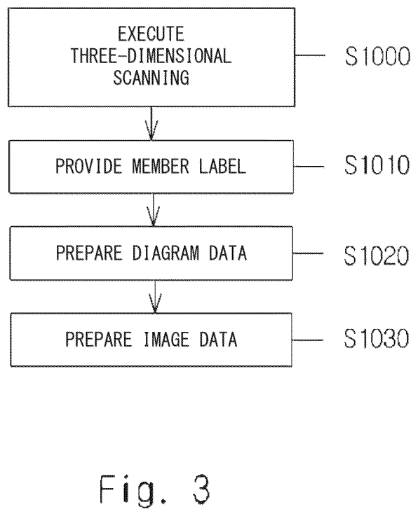

Herein, with reference to FIG. 3, description is made on a preparation flow executed before the data display apparatus 100 is actually used.

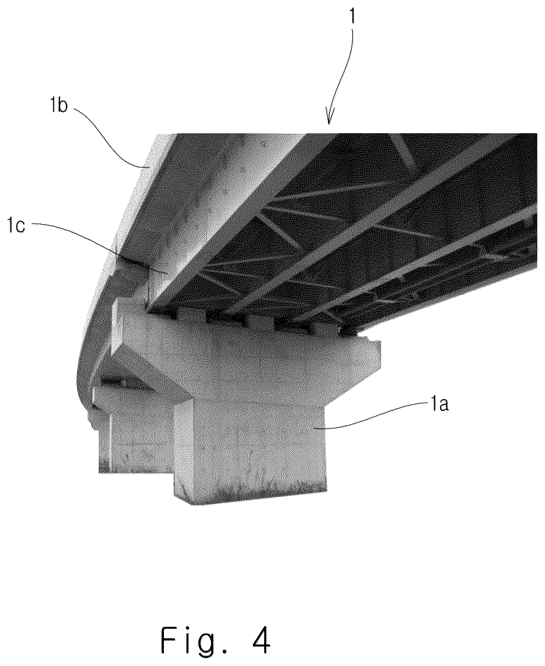

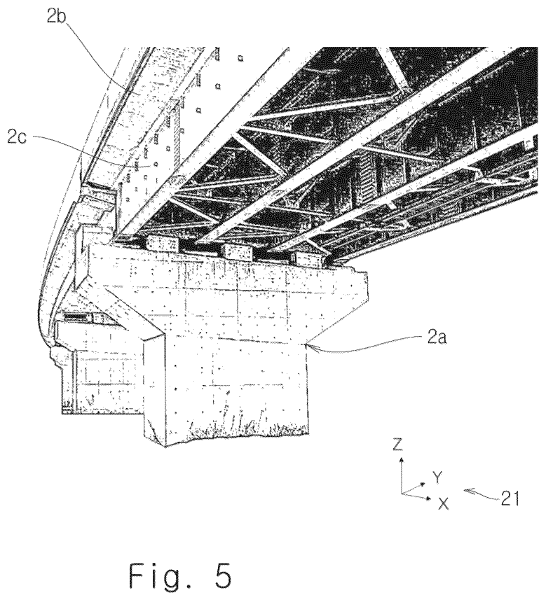

As illustrated in FIG. 3, first, three-dimensional data relating to the target object is generated by subjecting the target object to three-dimensional scanning, and is recorded in the three-dimensional data storage unit 101 (S1000). The target object is constructed by a combination of a plurality of members. FIG. 4 illustrates a photograph of the target object. In the example of FIG. 4, a target object 1 is a bridge consisting of various members such as a member 1a being a bridge pier, a member 1b being a slab, and a member 1c being a girder. FIG. 5 illustrates three-dimensional data 2 being three-dimensional data relating to the target object 1. The three-dimensional data 2 belongs to a three-dimensional space defined by a coordinate system 21. In other words, a specific position on the three-dimensional data 2 or a specific position in the periphery of the three-dimensional data 2 can be expressed by the coordinate system 21. A vertically-upward direction is defined as a positive Z-axis direction. In the longitudinal direction of the bridge, a direction toward the front side of the drawing is defined as a positive X-axis direction. In a direction orthogonal to the positive X-axis direction and the positive Z-axis direction, a direction toward the right side of the drawing is defined as a positive Y-axis direction. The coordinate system 21 is an orthogonal coordinate system.

The three-dimensional data 2 is data expressing a three-dimensional structure of the target object 1 in an actual world. The three-dimensional data 2 includes a group of a plurality of three-dimensional points. The three-dimensional point is data expressing a specific position, in the three-dimensional space defined by the coordinate system 21. For example, the three-dimensional data 2 is pint cloud data or mesh data.

Three-dimensional scanning is not limited to a specific method as long as the three-dimensional data 2 expressing the target object 1 in an actual world is generated. For example, three-dimensional scanning is executed by using a light detection and ranging (LiDAR) scanner or a camera. The LiDAR scanner is a sensor that acquires, as point cloud data with a photographing position as the origin, a three-dimensional structure of a surrounding environment by irradiation with laser light and analysis of reflected light. For example, a method of generating the three-dimension data 2 by the LiDAR is achieved by executing three-dimensional scanning by the LiDAR from at least one position in the periphery of the target object 1, acquiring at least one piece of point cloud data, and then applying a method of combining a plurality of pieces of point cloud data, such as the iterative closest point (ICP) algorithm. For example, a method of generating the three-dimensional data 2 by a camera is achieved by photographing the target object 1 from a plurality of positions or directions, acquiring a plurality of photographs, and then applying a method of generating point cloud data from the plurality of photographs, such as the structure-from-motion (SfM) algorithm.

Further, during three-dimensional scanning, the three-dimensional data 2 may be generated as mesh data by a method of converting point cloud data into mesh data or a method using design information relating to the target object 1. For example, the method of converting point cloud data into mesh data is achieved by generating point cloud data relating to the target object 1 by the method described above, and applying an algorithm for converting point cloud data into mesh data, such as the Poisson surface reconstruction algorithm. For example, the method of using the design information relating to the target object 1 is achieved by expressing a three-dimensional structure of the target object 1 as a combination of simple three-dimensional figures such as a rectangular parallelepiped shape and a cylinder, and expressing each of the three-dimensional figures as mesh data.

Referring back to FIG. 3, subsequently, each of the three-dimensional points constituting the three-dimensional data 2 is provided with a member label for identifying which member of the target object 1 the three-dimensional point represents (S1010). In the example of FIG. 5, a three-dimensional point 2a is positioned at the member 1a being the member 1a of the target object 1. Therefore, the three-dimensional point 2a is provided with a member label (hereinafter, a member label a) indicating the member 1a. Similarly, a three-dimensional point 2b is provided with a member label indicating the member 1b, and a three-dimensional point 2c is provided with a member label indicating the member 1c. When the target object 1 includes a plurality of members of the same type, for example, a plurality of bridge piers, the member label is provided in such a way as to distinguish the members of the same type from each other. In other words, the member label expresses an individual member, instead of a member type. The member label is a member identification label for identifying a member.

The member label is provided manually or automatically. For example, as a method of automatically providing the member label, deep learning with respect to point cloud data, such as Point Net, is used.

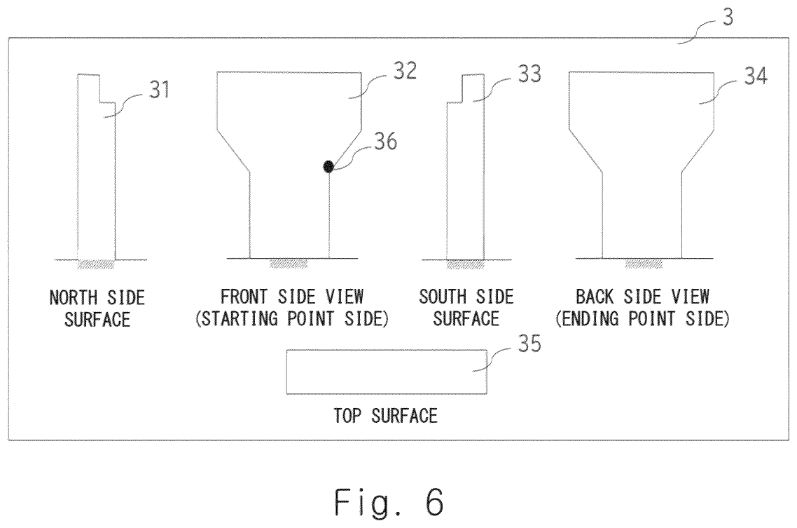

Referring back to FIG. 3, subsequently, diagram data is prepared for each of the members of the target object 1, and is recorded in the diagram data storage unit 107 (S1020). The diagram data is two-dimensional data for expressing a member having a three-dimensional structure in an actual world as at least one projection diagram. The diagram data is used for generating a damage diagram in which degradation of a bridge is recorded. For example, during an inspection of a bridge, an inspector records a state of deformations generated in a member, such as cracks and rust, in the diagram indicated by the diagram data. FIG. 6 illustrates diagram data relating to the member 1a, as an example of the diagram data. Diagram data 3 expresses a bridge pier having a three-dimensional structure, with five different projection diagrams including projection diagrams 31 to 35.

In step S1020, information in which a position in the projection diagram and a position in the three-dimensional data 2 are associated with each other may be recorded in the diagram data storage unit 107, together with the diagram data. In the example of FIG. 6, a vertex 36 in the projection diagram 32 indicates the same point as a three-dimensional point 2a in the three-dimensional data 2. In this manner, a plurality of positions are selected from a projection diagram and are associated with positions indicating the same points in the three-dimensional data 2, and then information relating to the association therebetween can be stored in the diagram data storage unit 107. As described later, the information relating to the association therebetween may be used in a step in which the diagram data display unit 108 aligns a position of a matter, which occurs to the target object 1, with a position in the diagram.

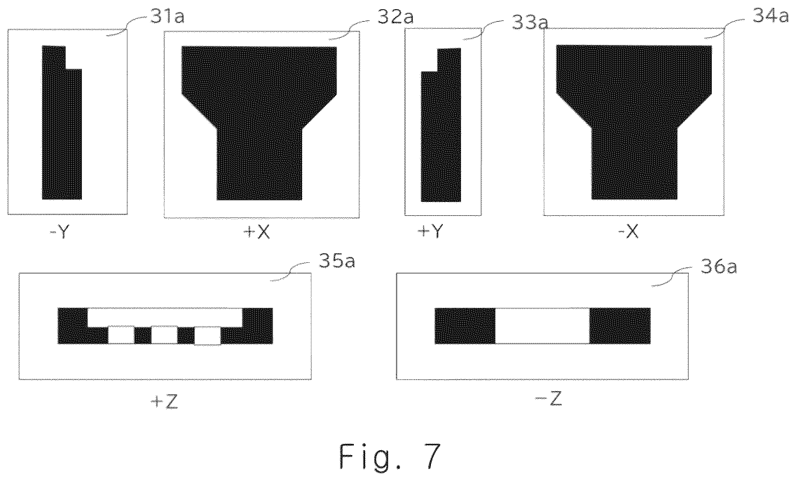

In step S1020, the diagram data to be recorded in the diagram data storage unit 107 may be generated from the three-dimensional data 2. For example, the diagram data can be generated by extracting, from the three-dimensional data 2, a three-dimensional point having a specific member label as three-dimensional data relating to a member, projecting the three-dimensional data relating to the member in a plurality of three-dimensional directions, generating a projection image, and then extracting a contour of the projection image. FIG. 7 illustrates a projection image of the member 1a as an example of the projection image. Projection images 31a to 36a are projection images that are generated by projecting three dimensional data relating to a member including three-dimensional point provided with the member label a in the −Y direction, the +X direction, the +Y direction, the −X direction, the +Z direction, and the −Z direction, respectively. In the example of FIG. 7, the projection image is a black and white image in which a region with a three-dimensional point is black and a region without it is white. By extracting a contour part from each of the projection images, the diagram data can be generated. However, the projection image 36a is a projection in the −Z direction, in other words, in the direction of looking up from the ground, and the region expressed by the projection image 36a is included in the projection image 31a and the projection image 32a. Therefore, the projection image 36a is not required for expressing the member 1a. A projection diagram generated in a direction that is not required for expressing a member, for example, the −Z direction with respect to the member 1a, may not be stored in the diagram data storage unit 107. Whether a direction is required for expressing a member may be determined by, for example, acquiring distribution of normal directions with respect to the three-dimensional data relating to the member and determining whether the normal directions is a direction being the −Z direction and falling below a predetermined ratio. In a case of the member 1a, there is almost no point at which the normal direction is the −Z direction, and hence it can be determined that the −Z direction is not required for expressing a member. Alternatively, when the member has a simple shape such as a rectangular parallelepiped shape, a direction where a region with a three-dimensional point falls below a predetermined ratio in the projection image can be determined as a direction not required for expressing the member. In other words, with reference to the example of FIG. 7, a direction where the number of black pixels falls below a predetermined ratio in the projection image can be determined as a direction not required for expressing the member.

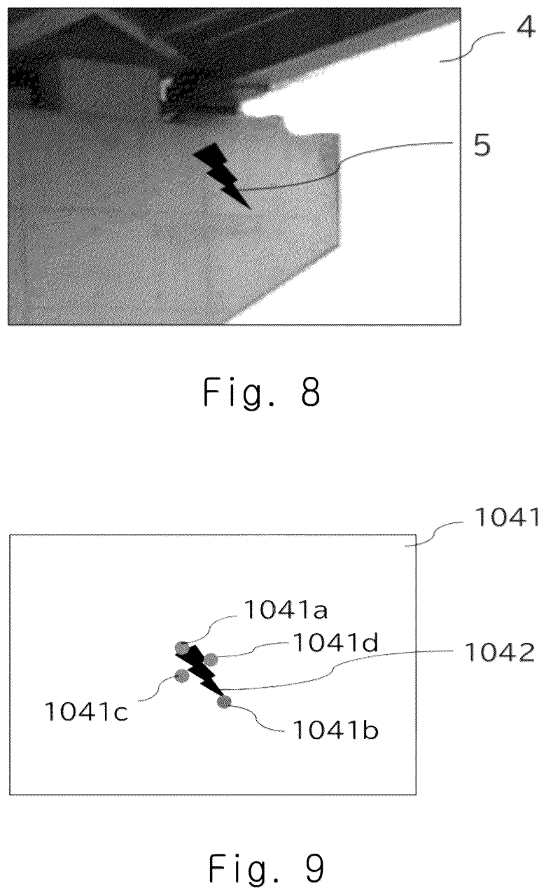

Referring back to FIG. 3, subsequently, a matter occurring to the target object 1 is photographed by a camera, and image data is prepared (S1030). FIG. 8 is an example of the image data. In the example of FIG. 8, image data 4 is acquired by photographing a matter 5, that is, a crack generated in a bridge pier. The image data 4 is used later as an input when the data display apparatus 100 is used.

The preparation flow is not limited to the order in FIG. 3. The processing may be executed in any freely-selected order, for example, an order in which step S1010 is executed after step S1000. In particular, step S1030 may be executed before step S1000. In other words, the data display apparatus 100 may be used for image data photographed before subjecting the target object 1 to three-dimensional scanning.

### (Data Display Apparatus 100)

Referring back to FIG. 2, the three-dimensional data storage unit 101 holds the three-dimensional data 2 being generated in the preparation flow. As described above, each of the three-dimensional points constituting the three-dimensional data 2 is provided with the member label.

The image data input unit 102 receives the image data 4 and camera information when the image data 4 is photographed. The camera information is information that includes a focal distance at the time of photographing and can be acquired from the camera.

The photographing position pose estimation unit 103 estimates, as a photographing position pose 1031, a photographing position pose of the image data 4 on the coordinate system 21, based on the three-dimensional data 2 and the image data 4. In other words, the photographing position pose estimation unit 103 estimates, on the coordinate system 21, a position pose of the camera in an actual world when the image data 4 is photographed. An expression of the photographing position pose 1031 is not limited to a specific expression as long as six degrees of freedom of a camera position pose is expressed. For example, the photographing position pose 1031 is expressed s an external parameter of the camera.

A method of estimating a photographing position pose by the photographing position pose estimation unit 103 is not specifically limited. A technique of estimating a photographing position pose of a camera in a three-dimensional space is typically called visual localization. For example, similarly to Render Net, which is a publicly-known technique, the photographing position pose estimation unit 103 may use a method of comparing a rendering image with image data, the rendering image being acquired by drawing three-dimensional data by various camera position poses being set in a three-dimensional space. In brief, first, a plurality of rendering images are generated by drawing three-dimensional data by a plurality of camera position poses being set in advance, global feature values of the image data and each of the rendering images are calculated, and the rendering image similar to the image data is selected based on comparison between the global feature values. Then, an image matching technique of associating pixels indicating the same point with each other is applied to the rendering image being selected and the image data. Then, each pixel of the rendering image indicates a specific position in the three-dimensional data, and hence a correlation between the two-dimension and the three-dimension, in which a specific pixel in the image data and a specific position in the three-dimensional data are associated with each other, is acquired based on the image matching result being acquired. Then, by applying a method of calculating a photographing position pose of image data, based on correlation between a two-dimension and a three-dimension, such as the perspective-n-points (PnP) algorithm, the photographing position pose of the image data can be estimated.

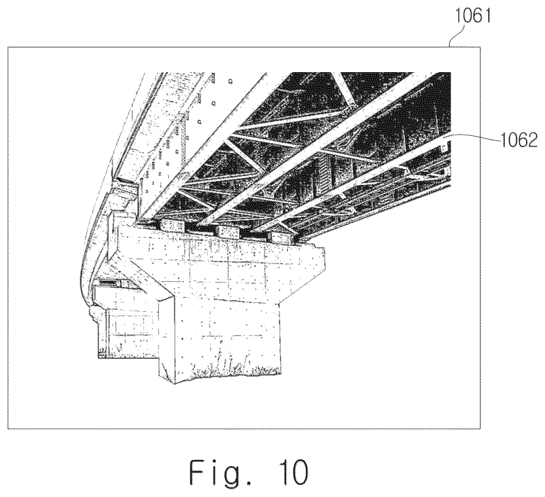

The matter analysis unit 104 detects the position of the matter 5 from the image data 4 illustrated in FIG. 8. For example, the matter analysis unit 104 specifies a pixel expressing the matter 5 from the image data 4 through image semantic segmentation, and generates a mask image expressing the position of the matter 5. For example, the matter analysis unit 104 generates a mask image by deep learning such as U-Net. FIG. 9 is an example of the mask image for the matter 5 in the image data 4. A mask image 1041 is a black and white image, and a position at which the matter 5 is detected from the image data 4 is expressed as a region 1042.

The matter analysis unit 104 estimates the size of the matter 5, based on the photographing position pose 1031. For example, the size of the matter 5 is a length and a width of the matter 5, and a length of one side of a rectangle surrounding the matter 5. In the example of FIG. 9, coordinates of a pixel 1041a and a pixel 1041b on the three-dimensional data 2 are calculated, and the length of the matter 5 is calculated as a length between the coordinates. Further, coordinates of a pixel 1041c and a pixel 1041d on the coordinate system 21 are calculated, and the width of the matter 5 is calculated as a length between the coordinates.

Herein, for a specific pixel in an image in which a photographing position pose and a focal distance are known, coordinates thereof on the coordinate system 21 can be calculated in the following manner. First, a field angle of the camera is acquired based on the focal distance, and hence a semi-line indicating a direction in which the specific pixel is viewed from the photographing position is acquired. Subsequently, the coordinates of the specific pixel on the coordinate system 21 are acquired by acquiring a collision point between the semi-line being acquired and the three-dimensional data 2. When the three-dimensional data 2 is mesh data, the collision point between the semi-line and the three-dimensional data 2 can be calculated as an intersection point closest to the photographing position among intersection points between each of planes constituting the mesh data and the semi-line. Further, when the three-dimensional data is point cloud data, the collision point between the semi-line and the three-dimensional data 2 can be calculated as a three-dimensional point closest to the photographing point, among the three-dimensional points included in the three-dimensional data 2, where a distance to the semi-line is equal to or less than a predetermined value. However, in such a case, the estimation accuracy of the coordinates is approximately equivalent to density of point cloud data, and the accuracy may be insufficient for applications such as calculating a width of a crack, where precision of 1 millimeter or less is required. In view of this, three-dimensional points in the vicinity of the collision point being acquired are extracted from the three-dimensional data 2 to create a set of vicinity points, the set of vicinity points are approximated with a plane, and an intersection between the plane and the semi-line is then adopted as the collision point. With this, the coordinates of the specific pixel on the coordinate system 21 are acquired at accuracy finer than density of point cloud data.

For example, the pixel 1041a and the pixel 1041b that define the length of the matter is calculated as an end point of the region 1042 in the longitudinal direction. Further, for example, the pixel 1041c and the pixel 1041d that define the width of the matter is calculated as an end point of the region 1042 in the longitudinal direction and the vertical direction.

The member identification unit 105 identifies the member being captured in the image data 4, based on the photographing position pose 1031, and outputs it as a member identification result 1051. For example, the member identification unit 105 calculates member labels for all the pixels of the image data 4, and outputs the member label with the largest number of pixels as the member identification result 1051. Alternatively, for example, the member identification unit 105 calculates a member label for the center pixel of the image data 4, and then outputs the member label as the member identification result 1051. For example, in the method of calculating a member label for a specific pixel of the image data 4 by the member identification unit 105, first, the coordinates of the specific pixel of the image data 4 on the coordinate system 21 are calculated by the method described above, using the photographing position pose 1031 and the focal distance. Subsequently, the three-dimensional point closest to the coordinates being calculated is retrieved from the three-dimensional points of the three-dimensional data 2, and the member label of the three-dimensional point being retrieved is referred to, and thereby the member label of the specific pixel of the image data 4 can be calculated.

When calculation is executed after the matter analysis unit 104, the member identification unit 105 may calculate the member identification result 1051, based on the mask image 1041 being generated by the matter analysis unit 104. For example, the member identification unit 105 calculates member labels for the entire region 1042 in the mask image 1041, and then outputs the member label with the largest number of pixels as the member identification result 1051.

The three-dimensional data display unit 106 presents a photographing range of the image data 4 for the target object 1 in a three-dimensional manner by displaying the image data 4 and the three-dimensional data 2 on the LCD 3000 in a superposed manner. The three-dimensional data display unit 106 changes a display method from a state of displaying only the three-dimensional data 2 to a state of displaying the image data 4 and the three-dimensional data 2 in a superposed manner. FIG. 10 is an example of a state of presenting an overview of the three-dimensional data 2. The region 1061 is a region in which the three-dimensional data display unit 106 display data. For example, the region 1061 is a display, a window, or a part of a window.

The medium 1062 is an image, a moving image, or three-dimensional data display illustrating an overall schematic view of the three-dimensional data 2. For example, the image is an image that provides an overview of the three-dimensional data 2. For example, the moving image is a moving image in which the three-dimensional data 2 is displayed while rotating in the region 1061. The three-dimensional data display is a media format that receives an input from a mouse, a touch panel, or the like, and displays the three-dimensional data 2 while rotating, zooming-out, or zooming-in the three-dimensional data 2 according to drag-and-drop by a mouse or a sliding action on a touch panel, for example.

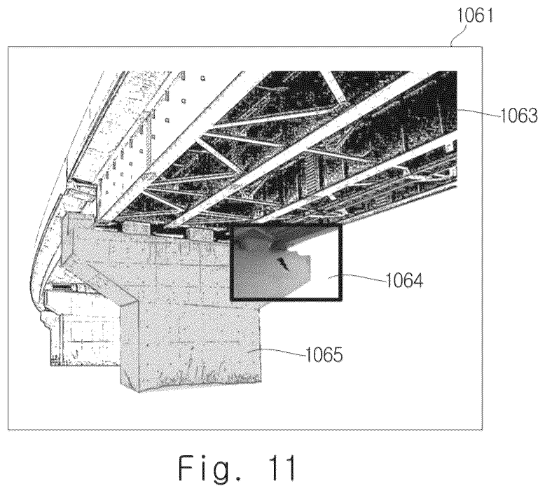

FIG. 11 is an example of a state in which the image data 4 and the three-dimensional data 2 are displayed in superposed manner. A medium 1063 includes a display 1064 in which a color of the image data 4 is superposed on the three-dimensional data 2, and thereby presents the photographing range of the image data 4 in such a way as to facilitate visual recognition thereof on the target object 1. Further, the medium 1063 may display the three-dimensional data relating to the member indicated by the member identification result 1051 in a highlighted manner, as in a display 1065. Highlighting is, for example, mixing a specific color such as red with a color of the three-dimensional data 2. In the example of FIG. 11, the medium 1063 displays a bridge pier in a highlighted manner in the display 1065 by mixing a gray color in a part associated with bridge pier. With this highlighting, the display 1064 can be emphasized more.

For example, As a method of displaying the image data 4 and the three-dimensional data 2 in superposed manner by the three-dimensional data display unit 106, a method of arranging an image object, a method of coloring three-dimensional data, or a method of superpose display on a drawing image from a predetermined viewpoint can be adopted.

The method of arranging an image object is a method of arranging the image data 4 as a three-dimensional object on the coordinate system 21 and simultaneously displaying the three-dimensional object being arranged and the three-dimensional data 2. For example, in the method of arranging an image object, first, an image plane in a perspective projection model of the camera is arranged as a three-dimensional plane object on the coordinate system 21, based on the photographing position pose 1031 and the focal distance. Subsequently, the image data 4 is pasted on the image plane. Subsequently, the image plane and the three-dimensional data 2 are simultaneously displayed at a position behind the photographing position pose 1031. When the method of arranging an image object is used, the medium 1063 may be in any display format including an image, a moving image, and three-dimensional data display.

The method of coloring three-dimensional data is a method of coloring a part of the three-dimensional data 2, which is included in the photographing range of the image data 4, with the image data 4 and displaying the three-dimensional data 2 being colored. As described above, the coordinates on the coordinate system 21 can be calculated for each of the pixels of the image data 4. Therefore, for example, each of the pixels of the image data 4 can color the three-dimensional data 2 by overwriting a color of the closest three-dimensional point on the coordinate system 21 among the three-dimensional points of the three-dimensional data 2. However, in a case in which the coordinates are calculated by the method described above, when the three-dimensional data 2 is point cloud data, the coordinates can be calculated at accuracy finer than the density of the point cloud data. In such a case, when the medium 1063 displays the three-dimensional data 2, the three-dimensional data display unit 106 may add a new three-dimensional point at the position associated with the coordinates being calculated. In this case, the region to be colored is drawn at the density higher than the density of the three-dimensional data 2, and hence the photographing range of the image data 4 can be emphasized more. When the method of coloring three-dimensional data is used, the medium 1063 may be in any display format including an image, a moving image, and three-dimensional data display.

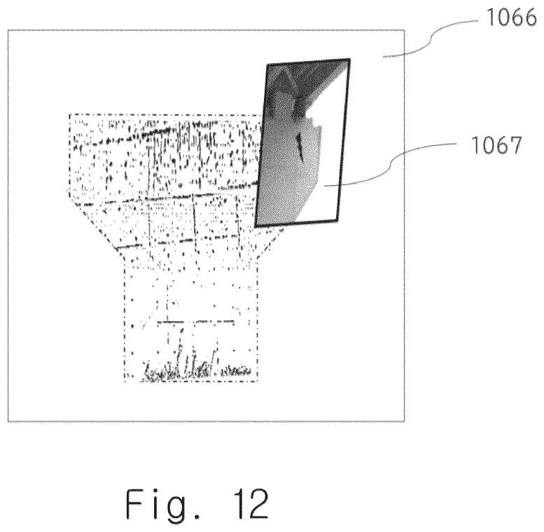

In the method of superpose display on a drawing image from a predetermined viewpoint, a position pose at the time of drawing is set for each member, a member image is created according to the member identification result 1051 by drawing the three-dimensional data 2 from the position pose being set, and then the image data 4 is deformed and superposed on the member image. For example, the position pose at the time of drawing is set in such a way that one surface of the member fits within the field angle. FIG. 12 is an example in which the image data 4 is deformed and superposed on the member image. In the example of FIG. 12, the position pose at the time of drawing is set in such a way as to photograph the part of the three-dimensional data 2, which is associated with the member 1a, from the front side, and a member image 1066 is created. In the example of FIG. 12, only the part of the three-dimensional data 2, which is associated with the member 1a, is drawn, but the member image may include parts other than the part of the three-dimensional data 2, which is associated with the member 1a, as long as the position pose at the time of drawing is set by focusing on the target member. In FIG. 12, an image 1067 acquired by deforming the image data 4 is displayed as an image on the member image 1066 being created, in a superposed manner.

For example, as a method of deforming the image data 4, the homography transformation may be adopted. In the homography transformation, the image data 4 is deformed in such a way that distances between point correlations are reduced, based on four or more N point correlations between the image data 4 and the member image 1066. The point correlations are calculated in the following manner. First, based on the photographing position pose 1031 and the focal distance, the coordinates on the coordinate system 21 are calculated for N points in the image data 4. Subsequently, for each of the N sets of coordinates, a position in the member image 1066 is calculated. By the processing described above, the N point correlations between the image data 4 and the member image 1066 are acquired. For example, the N points in the image data 4 are acquired by randomly extracting N points from pixels in the image data 4, which represent the same member as the member identification result 1051. Whether a specific pixel of the image data 4 represents the same member as the member identification result 1051 can be determined by acquiring the coordinates on the coordinate system 21 for the specific pixel of the image data 4, and determining whether the member label of the closest three-dimensional point represents the same member as the member identification result 1051.

When the display method is changed from the state of displaying only the three-dimensional data 2 to the state of displaying the image data 4 and the three-dimensional data 2 in a superposed manner, the three-dimensional data display unit 106 may complementarily display the transition state therebetween as a moving image. For example, based on the position pose for drawing on the coordinate system 21 directly before the display method is changed and the position pose for drawing on the coordinate system 21 directly after the display method is changed, the three-dimensional data display unit 106 may calculate a plurality of position poses between those position poses, and draw the three-dimensional data 2 or the three-dimensional object by using each of the position poses being calculated, and thereby create the moving image.

The diagram data storage unit 107 holds the diagram data relating to each of the members of the target object.

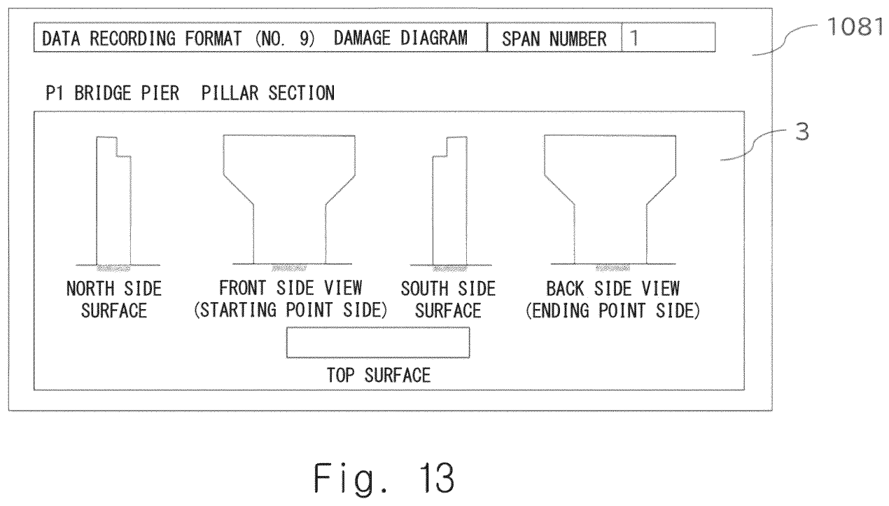

The diagram data display unit 108 displays, on the LCD 3000, the information relating to the position or size of the matter 5 on the diagram data in a superposed manner. The diagram data display unit 108 changes a display method from a state of only presenting the diagram data being recorded to a state of displaying the position or size of the matter being detected by the matter analysis unit 104, on the diagram data being associated with the member identification result 1051, in a superposed manner. FIG. 13 is an example of the state of only presenting the diagram data being recorded. A region 1081 is a region in which the diagram data display unit 108 display data. For example, the region 1081 is a display (the LCD 3000), a window, or a part of a window. The diagram data display unit 108 selects one piece of diagram data from the diagram data being stored in the diagram data storage unit 107, and displays the diagram data in the region 1081. For example, the diagram data being selected by the diagram data display unit 108 is diagram data relating to a member with the largest area or diagram data relating to the first member to be inspected during inspection work. In the example of FIG. 13, the diagram data 3 relating to the member 1a is displayed.

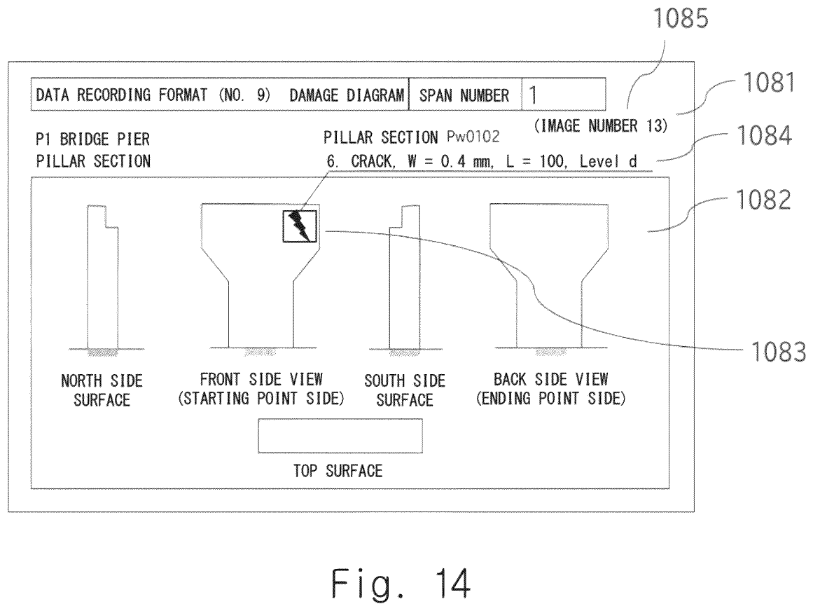

FIG. 14 is an example of a state in which the position or size of the matter being detected by the matter analysis unit 104 is displayed on the diagram data being associated with the member identification result 1051, in a superposed manner. The diagram data display unit 108 displays, in the region 1081, diagram data 1082 being associated with the member identification result 1051, and displays position information 1083 relating to the position of the matter being detected by the matter analysis unit 104 or detail information 1084 relating to the size of the matter being detected by the matter analysis unit 104. In the example of FIG. 14, the diagram data 1082 is the diagram data relating to the member 1a to which the matter 5 occurs, the position information 1083 is the shape of the matter 5 on the diagram data 1082, and the detail information 1084 is classification according to the actual width or the actual length of the matter 5 or the magnitude or the extent of the matter 5. Further, the diagram data display unit 108 may display a image number 1085 for specifying the image data 4 on the diagram. By displaying the image number 1085, efficiency of a reverse look-up task in which a user retrieves a photograph capturing damage from the damage displayed on the diagram can be improved.

The shape of the matter 5 on the diagram data 1082 can be calculated in the following manner. First, when the diagram data 1082 include a plurality of projection diagrams, the diagram data display unit 108 specifies which projection diagram includes a surface to which the matter 5 occurs. For example, the surface to which the matter 5 occurs can be specified by calculating the coordinates on the coordinate system 21 for a certain pixel, which represents the matter 5, in the region 1042 of the mask image 1041 generated by the matter analysis unit 104, and calculating a surface of the member to which the coordinates being calculated belong. Alternatively, the surface to which the matter 5 occurs is specified by calculating which surface of the member is closest to the photographing position pose 1031.

Subsequently, the diagram data display unit 108 specifies the shape of the matter 5 in the projection diagram being specified. For example, the diagram data display unit 108 generates a projection image by projecting the three-dimensional data relating to the member in the projection direction of the projection diagram, and converts the shape of the matter 5 on the projection image into the shape thereof on the projection diagram by aligning the projection image with the projection diagram. For example, the shape of the matter 5 on the projection image is acquired by calculating the homography transformation from the mask image 1041 being generated by the matter analysis unit 104 to the projection image, and converting the region 1042 of the mask image 1041 into the coordinate system for the pixels on the projection image by the homography transformation being calculated.

For example, in the method of aligning the projection image with the projection diagram, a contour is extracted from the projection image, a vertex is calculated by approximating the contour being extracted with a polygon, and then the vertex is aligned with a vertex in the projection diagram. Alternatively, in the preparation flow, when information in which positions in the projection diagram and positions in the three-dimensional data 2 are associated with each other is generated, aligning may be executed by using the information. The projection image is generated from the three-dimensional data 2, and hence the information in which positions in the projection diagram and positions in the three-dimensional data 2 are associated with each other can be calculated. The projection image can be aligned with the projection diagram in such a way that the distances between the positions being associated with each other are reduced.

The diagram data display unit 108 may change the display method for the position information 1083 or the detail information 1084, according to whether the matter is new, or whether the matter is changed when the matter is new. For example, with regard to determination on whether the matter is new, when a shape of a matter is previously recorded at a position similar to the position information 1083, it is no determined that the matter is new. For example, with regard to determination on whether the matter is changed, a change amount of a shape or size of a matter is calculated by comparing the shape of the matter being previously recorded and the position information 1083 with each other or comparing the size of the matter being previously recorded and the detail information 1084 with each other, and it is determined that the matter is changed when the change amount exceeds a predetermined threshold value. For example, the diagram data display unit 108 may display the position information 1083 and the detail information 1084 in a color of red when the matter is new or the matter is changed, and in a color of black when the matter is not changed. Further, in a case in which the matter is not new, when the detail information 1084 is displayed, the diagram data display unit 108 may display the size of the matter being previously recorded and the size of the matter 5 side by side.

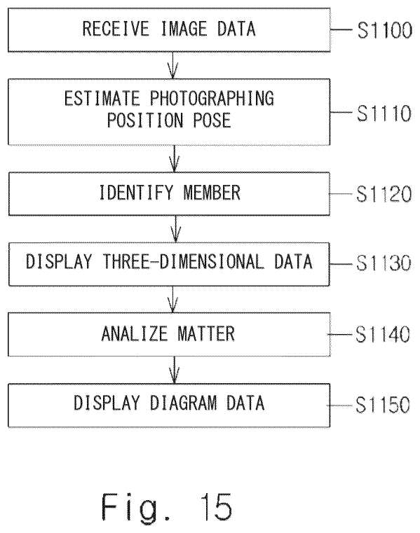

Next, with reference to FIG. 15, a control flow of the data display apparatus 100 is described.

First, the image data input unit 102 receives the image data 4 (S1100).

Subsequently, the photographing position pose estimation unit 103 estimates the photographing position pose 1031 (S1110).

Subsequently, the member identification unit 105 identifies the member being captured in the image data 4, based on the photographing position pose 1031 (S1120).

Subsequently, the three-dimensional data display unit 106 changes the display method from the state of displaying only the three-dimensional data 2 to the state of displaying the image data 4 and the three-dimensional data 2 in a superposed manner (S1130).

Subsequently, the matter analysis unit 104 detects the matter 5 from the image data 4, and calculates the size of the matter 5, based on the photographing position pose 1031 (S1140).

Subsequently, the diagram data display unit 108 changes the display method from the state of presenting the diagram data being recorded to the state of displaying the position or size of the matter being detected by the matter analysis unit 104, on the diagram data being associated with the member identification result 1051, in a superposed manner (S1150).

The control flow is not limited to the order in FIG. 15. The processing may be executed in an any freely-selected order, for example, in an order in which step S1110 is executed after step S1100, step S1120 is executed after step S1110, step S1130 is executed after step S1110, step S1140 is executed after S1100, and step S1150 is executed after step S1120 and step S1140.

The first example embodiment is described above, and the example embodiment described above includes the following features.

As illustrated in FIG. 2, the data display apparatus 100 includes the photographing position pose estimation unit 103, the matter analysis unit 104, the member identification unit 105, the three-dimensional data display unit 106, and the diagram data display unit 108. The photographing position pose estimation unit 103 estimates the photographing position pose of the image data on the coordinate system of the three-dimensional data. The matter analysis unit 104 detects the position or size of the matter from the image data. The member identification unit 105 identifies the member being captured in the image data, based on the photographing position pose. The three-dimensional data display unit 106 displays the image data and the three-dimensional data in a superposed manner. The diagram data display unit 108 displays the matter on the diagram data relating to the member in a superposed manner, based on the photographing position pose. According to the configuration described above, when the image data is received, the data display apparatus 100 is capable of presenting the image data on the three-dimensional data relating to the target object in a superposed manner, and is further capable of detecting the matter being captured in the image data and displaying the detection result on the diagram data relating to the member being captured in the image, in a superposed manner. In other words, according to the configuration described above, the photographing range of the image can be presented in the three-dimensional space, and the matter captured in the image can be displayed on the diagram.

The data display apparatus 100 includes the photographing position pose estimation unit 103 that estimates the photographing position pose of the image data on the coordinate system of the three-dimensional data, the matter analysis unit 104 that detects the position of the predetermined matter from the image data, and the diagram data display unit 108 that displays the position of the matter on the diagram data in a superposed manner, based on the photographing position pose and an analysis result of the matter analysis unit 104. According to the configuration described above, the matter captured in the image can be displayed on the diagram.

### Second Example Embodiment

A second example embodiment is described below. Difference between the present example embodiment and the first example embodiment described above are mainly described below, and overlapping description is omitted.

In the first example embodiment described above, a user can intuitively grasp a photographing position of a photograph in a three-dimensional space by photographing a matter occurring to a target object with a camera, and can confirm that information relating to the matter being detected is superposed on diagram data.

However, for a user who desires to conduct a detailed analysis on a matter's change due to aging, direct comparison with previous photographs is required in addition to confirming updates on diagram data.

In view of this, in the present example embodiment, a previous photograph, which is required for direct comparison, is presented automatically.

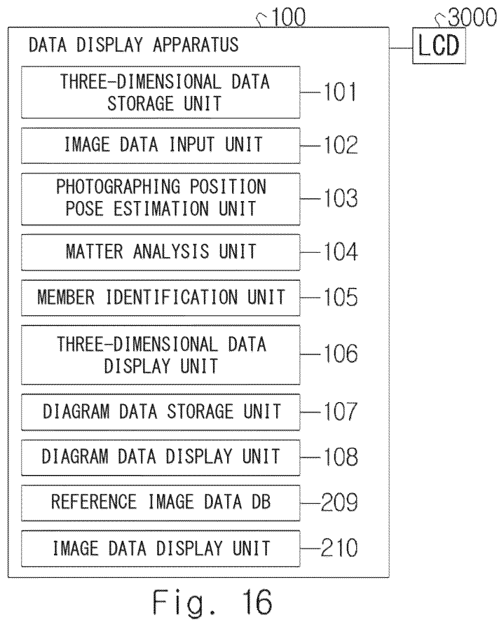

FIG. 16 illustrates a functional block diagram of a data display apparatus 200. The data display apparatus 200 includes a reference image data database (DB) 209 and an image data display unit 210, in addition to the functions of the data display apparatus 100.

### (Preparation Flow)

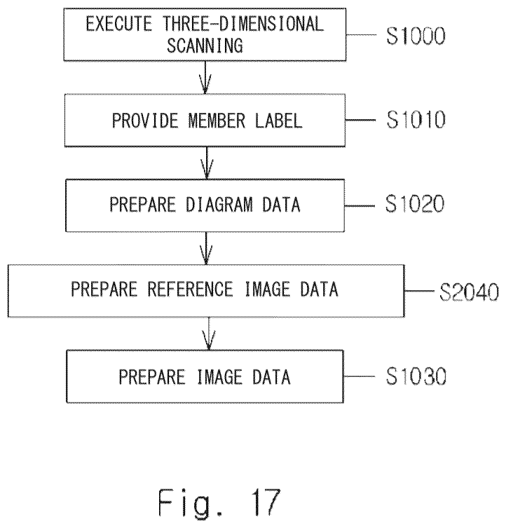

Herein, with reference to FIG. 17, description is made on a preparation flow executed before the data display apparatus 200 is actually used. The preparation flow of the present example embodiment is acquired by adding step S2040 to the preparation flow of the first example embodiment described above.

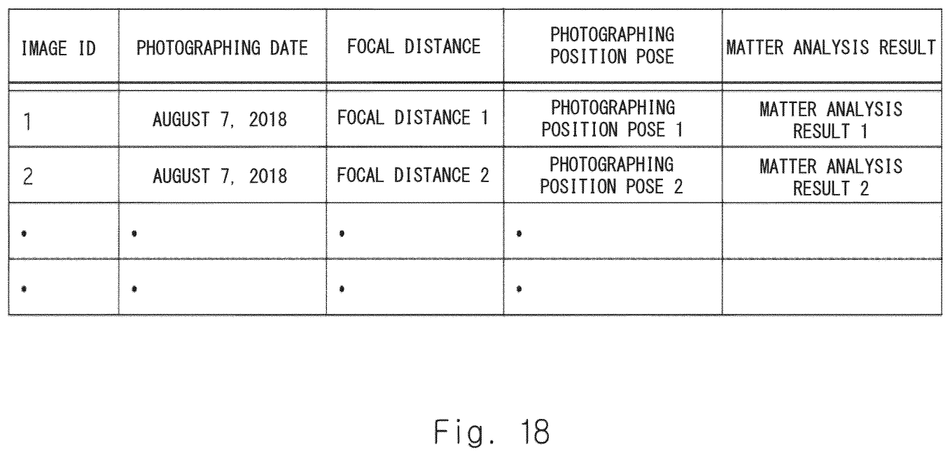

Step S2040 is a step of generating a reference image data DB and storing the reference image data DB being generated in the reference image data DB 209. The reference image data DB is a DB that manages reference image data capturing various matters occurring to the target object 1, in association with a photographing data, a focal distance, a photographing position and pose on the coordinate system 21, and a matter analysis result that records a mask image of a matter, a size of a matter, a position of a matter on a diagram data, and the like. For example, the reference image data is an inspection photograph that is taken during an previous inspection. In the reference image data DB, each piece of the reference image data is managed by using an image ID being uniquely assigned thereto as a key. FIG. 18 is an example of the reference image data DB. For example, the photographing position pose is calculated by applying the photographing position pose estimation unit 103 to the reference image data. For example, the matter analysis result is calculated by applying the matter analysis unit 104 to the reference image data.

The preparation flow is not limited to the order in FIG. 17. S2040 may be executed at any freely-selected timing after S1000.

### (Data Display Apparatus 200)

Referring back to FIG. 16, the reference image data DB 209 holds the reference image data DB being generated in the preparation flow.

The image data display unit 210 retrieves, on the LCD 3000, similar reference image data from the reference image data DB, based on the photographing position pose being estimated by the photographing position pose estimation unit 103, and simultaneously displays the reference image data being retrieved and the image data 4. For example, in the method of retrieving similar reference image data, reference image data with high similarity in photographing position pose is retrieved. For example, when the photographing position pose is expressed by an external parameter of the camera, the similarity level of the photographing position pose is measured by a low norm of a difference in a rotation matrix included in the external parameter or a low norm of a difference in a translation vector included in the external parameter. Alternatively, for example, in the method of retrieving similar reference image data, a reference image data with a high overlapping rate of the photographing range is retrieved. In this case, based on the photographing position pose 1031 and the focal distance of the image data 4, a set of three-dimensional points, which are included within the field angle of the image data 4, of the three-dimensional data 2 is calculated as the photographing range of the image data 4. Further, based on the photographing position pose of the reference image data and the focal distance of the reference image data, a set of three-dimensional points, which are included within the field angle of the reference image data, of the three-dimensional data 2 is calculated as the photographing range of the reference image data. Further, an overlapping rate between the photographing range of the image data 4 and the photographing range of the reference image data is calculated. Alternatively, for example, in the method of retrieving similar reference image data, reference image data with a similar position of the matter on the diagram data may be retrieved.

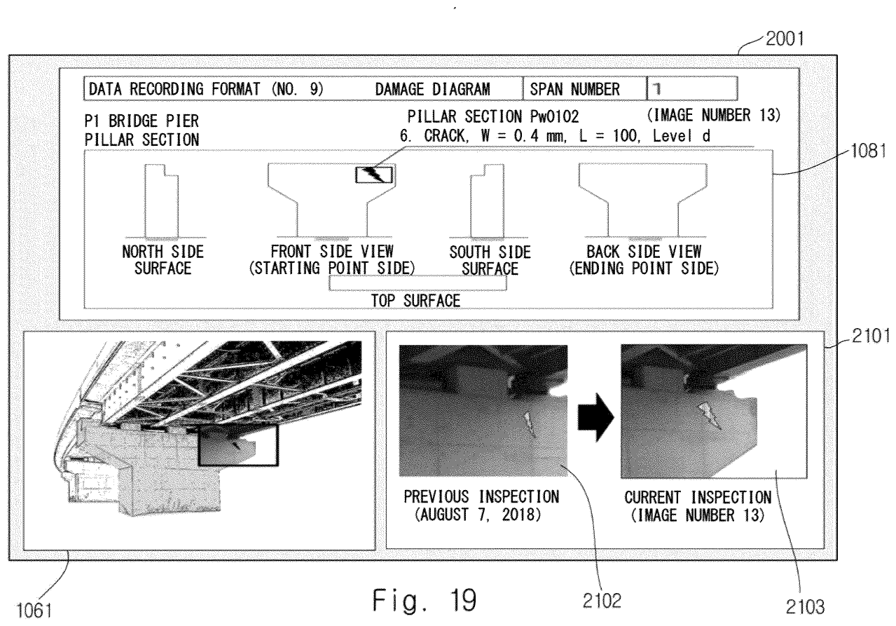

The data display apparatus 200 may display at least two of the display result of the three-dimensional data display unit 106, the display result of the diagram data display unit 108, and the display result of the image data display unit 210, side by side. FIG. 19 illustrates an example in which the display result of the three-dimensional data display unit 106, the display result of the diagram data display unit 108, and the display result of the image data display unit 210 are simultaneously displayed side by side on the LCD 3000. In the example of FIG. 19, the data display apparatus 200 displays the region 1061, the region 1081, and a region 2101 side by side in a region 2001. For example, the region 2001 is a display (the LCD 3000), a window, or a part of a window. The region 2101 is a display region of the image data display unit 210. The region 2101 includes a display 2102 relating to the reference image data and a display 2103 relating to the image data 4. For example, the region 2101 is a display (the LCD 3000), a window, or a part of a window. In the example of FIG. 19, the display 2102 displays a detection result of the matter indicated by the reference image data in a superposed manner on the reference image data. The display 2103 displays the detection result of the matter indicated by the image data 4 in a superposed manner on the image data 4. For example, the method of displaying the detection result of the matter on the image data in a superposed manner may be mixing a red color at the position of the matter on the image data. In the example of FIG. 19, the detection result of the matter is displayed on the image data in a superposed manner by drawing hatched lines at the position of the matter.

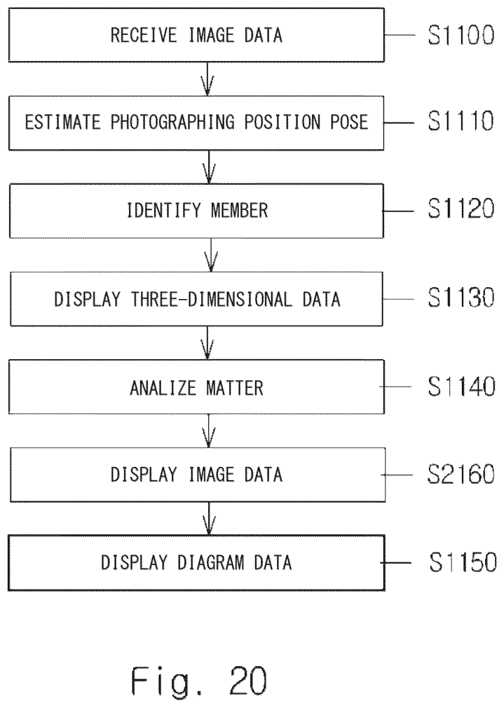

Next, with reference to FIG. 20, a control flow of the data display apparatus 200 is described. the control flow of the data display apparatus 200 is acquired by adding an image data display step S2160 for operating an image data display step S2160, to the control flow of the data display apparatus 100. The control flow of the data display apparatus 200 is not limited to the order in FIG. 20. Step S2160 may be executed at a freely-selected timing after step S1110.

The second example embodiment of the present disclosure is described above. The example embodiment described above includes the following features.

The data display apparatus 200 includes the reference image data DB 209 and the image data display unit 210. The reference image data DB 209 manages the plurality of reference images in association with a photographing date, an estimation result of the photographing position pose, and a detection result of the matter detection. The image data display unit 210 retrieves the reference image data whose photographing position pose is similar to that of the image data, and displays the image data and the reference image data being retrieved, side by side. According to the configuration described above, a user who desires to conduct a detailed analysis on a matter's change due to aging can perform direct comparison with previous photographs in addition to confirming updates on diagram data.

### INDUSTRIAL APPLICABILITY

The present disclosure is applicable to a purpose for recording a deformation, which is captured in an inspection photograph, on diagram data, based on the inspection photograph being photographed during a bridge inspection work.

Next, a hardware configuration of the data display apparatus 100 is described. In the data display apparatus 100, the three-dimensional data storage unit 101 and the diagram data storage unit 107 are memories. The image data input unit 102, the photographing position pose estimation unit 103, the matter analysis unit 104, the member identification unit 105, the three-dimensional data display unit 106, and the diagram data display unit 108 are achieved by a processing circuit. The processing circuit may be a processor and a memory that execute a program stored in the memory, or may be dedicated hardware.

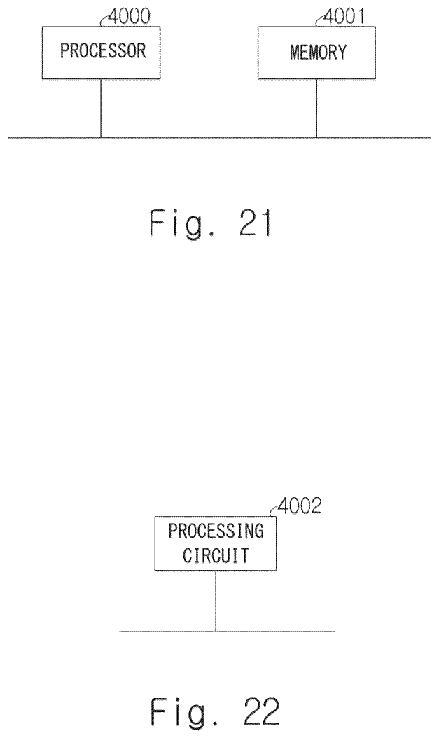

FIG. 21 is a diagram illustrating a case in which a processing circuit included in the data display apparatus 100 is configured by a processor and a memory. When the processing circuit is configured by a processor 4000 and a memory 4001, each of the functions of the processing circuit of the data display apparatus 100 is achieved by software, firmware, or a combination of software and firmware. The software or the firmware is described as a program, and is stored in the memory 4001. In the processing circuit, the program stored in the memory 4001 is read out and executed by the processor 4000, and thereby each of the functions is achieved. In other words, the processing circuit includes the memory 4001 for storing the program in such a way that the processing of the data display apparatus 100 is executed as a result. Further, it can also be understood that the program causes a computer to execute the procedure and the method of the data display apparatus 100.

Herein, the processor 4000 may be a central processing unit (CPU), a processing apparatus, an arithmetic apparatus, a microprocessor, a microcomputer, a digital signal processor (DSP), or the like. Further, for example, the memory 4001 corresponds to a non-volatile or volatile semiconductor memory, such as a random access memory (RAM), a read only memory (ROM), a flash memory, an erasable programmable ROM (EPROM), and an electrically EPROM (EEPROM) (registered trademark), a magnetic disk, a flexible disk, an optical disk, a compact disk, a mini disk, a digital versatile disc (DVD), or the like.

FIG. 22 is a diagram illustrating a case in which the processing circuit included in the data display apparatus 100 is configured by dedicated hardware. When the processing circuit is configured by dedicated hardware, a processing circuit 4002 corresponds to, for example, a single circuit, a compound circuit, a programmed processor, a parallelly-programmed processor, an application specific integrated circuit (ASIC), a field programmable gate array (FPGA), or a combination thereof. The functions of the data display apparatus 100 may be achieved by the processing circuit 4002 for each function, or the functions may be collectively achieved by the processing circuit 4002.

Note that, for each of the functions of the data display apparatus 100, part of them may be achieved by dedicated hardware, and part of them may be achieved by software or firmware. In this manner, each of the functions described above can be achieved by the processing circuit as dedicated hardware, software, firmware, or a combination thereof.

While the present disclosure is described above with reference to the example embodiments, the present disclosure is not limited to the example embodiments described above. Within the scope of the present disclosure, various changes that are understood by a person skilled in the art may be made to the configurations and details of the present disclosure. Further, each of the example embodiments may be appropriately combined with other example embodiments.

Each of the drawings is merely an example for describing one or more example embodiments. Each of the drawings may be associated with one or more other example embodiments instead of being associated with only one specific example embodiment. As understood by a person skilled in the art, various features or steps that are described with reference to any one of the drawings may be combined with features or steps that are illustrated in one or more other drawings in such a way as to create an example embodiment not being explicitly illustrated or described, for example. All the features or the steps that are illustrated in one or more drawings for describing an example embodiment being exemplary are not necessary, and some of the features or the steps may be omitted. An order of the steps described in any of the drawings may be changed as appropriate.

The whole or part of the exemplary embodiments disclosed above can be described as, but not limited to, the following supplementary notes.

### (Supplementary Note 1)

A data display system including:
a photographing position pose estimation means for estimating a photographing position pose of image data in a coordinate system of three-dimensional data;
a matter analysis means for detecting a position of a predetermined matter from the image data; and
a diagram data display means for displaying a position of the matter on diagram data in a superposed manner, based on the photographing position pose and an analysis result of the matter analysis means.

### (Supplementary Note 2)

The data display system according to Supplementary note 1, further including: a three-dimensional data display means for displaying the image data and the three-dimensional data in a superposed manner, based on the photographing position pose.

### (Supplementary Note 3)

The data display system according to Supplementary note 2, wherein a photographing range of the image data on a target object indicated by the three-dimensional data is presented by displaying the image data and the three-dimensional data in a superposed manner.

### (Supplementary Note 4)

The data display system according to Supplementary note 2, wherein a display method is changed from a state of displaying only the three-dimensional data to a state of displaying the image data and the three-dimensional data in a superposed manner.

### (Supplementary Note 5)

The data display system according to Supplementary note 2, wherein the three-dimensional data display means displays the image data and the three-dimensional data in a superposed manner by arranging the image data as a three-dimensional object on the coordinate system and simultaneously displaying the three-dimensional object being arranged and the three-dimensional data.

### (Supplementary Note 6)

The data display system according to Supplementary note 2, wherein the three-dimensional data display means displays the image data and the three-dimensional data in a superposed manner by coloring a part of the three-dimensional data, being included in the photographing range of the image data, based on the image data.

### (Supplementary Note 7)

The data display system according to Supplementary note 2, wherein the three-dimensional data display means displays the image data and the three-dimensional data in a superposed manner by generating a member image acquired by drawing the three-dimensional data from a predetermined viewpoint and deforming and superposing the image data on the member image.

### (Supplementary Note 8)

A data display apparatus including:
a photographing position pose estimation means for estimating a photographing position pose of image data in a coordinate system of three-dimensional data;
a matter analysis means for detecting a position of a predetermined matter from the image data; and
a diagram data display means for displaying a position of the matter on diagram data in a superposed manner, based on the photographing position pose and an analysis result of the matter analysis means.

### (Supplementary Note 9)

A data display method including, by a computer:
estimating a photographing position pose of image data in a coordinate system of three-dimensional data;
detecting a position of a predetermined matter from the image data; and
displaying a position of the matter on diagram data in a superposed manner, based on the photographing position pose and an analysis result of the matter analysis means.

### (Supplementary Note 10)

A program causing a computer to function as:
a photographing position pose estimation means for estimating a photographing position pose of image data in a coordinate system of three-dimensional data;
a matter analysis means for detecting a position of a predetermined matter from the image data; and
a diagram data display means for displaying a position of the matter on diagram data in a superposed manner, based on the photographing position pose and an analysis result of the matter analysis means.

Some or all of the elements (for example, the configurations and functions) described in Supplementary note 2 to Supplementary note 7, which are dependent on Supplementary note 1, may also be dependent on Supplementary note 8 to Supplementary note 10 due to similar dependency of Supplementary note 2 to Supplementary note 7. Some or all of the elements described in any freely-selected supplementary note may be applied to various types of hardware and software, a recording means for recording software, a system, and a method.

According to the present disclosure, a matter captured in an image can be displayed on a diagram.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The first and second embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A data display system comprising:
at least one memory storing computer-executable instructions; and
at least one processor configured to access the at least one memory and execute the computer-executable instructions to:
estimate a photographing position pose of image data in a coordinate system of three-dimensional data;
detect a position of a predetermined matter from the image data; and
display a position of the matter on diagram data in a superposed manner, based on the photographing position pose and the position of the predetermined matter.

2. The data display system according to claim 1, wherein the at least one processor is further configured to execute the instructions to
display the image data and the three-dimensional data in a superposed manner, based on the photographing position pose.

3. The data display system according to claim 2, wherein a photographing range of the image data on a target object indicated by the three-dimensional data is presented by displaying the image data and the three-dimensional data in a superposed manner.

4. The data display system according to claim 2, wherein a display method is changed from a state of displaying only the three-dimensional data to a state of displaying the image data and the three-dimensional data in a superposed manner.

5. The data display system according to claim 2, wherein the image data and the three-dimensional data are displayed in a superposed manner by arranging the image data as a three-dimensional object on the coordinate system and simultaneously displaying the three-dimensional object being arranged and the three-dimensional data.

6. The data display system according to claim 2, wherein the image data and the three-dimensional data are displayed in a superposed manner by coloring a part of the three-dimensional data, being included in the photographing range of the image data, based on the image data.

7. The data display system according to claim 2, wherein the image data and the three-dimensional data are displayed in a superposed manner by generating a member image acquired by drawing the three-dimensional data from a predetermined viewpoint and deforming and superposing the image data on the member image.

8. A data display apparatus comprising:
at least one memory storing computer-executable instructions; and
at least one processor configured to access the at least one memory and execute the computer-executable instructions to:
estimate a photographing position pose of image data in a coordinate system of three-dimensional data;
detect a position of a predetermined matter from the image data; and
display a position of the matter on diagram data in a superposed manner, based on the photographing position pose and the position of the predetermined matter.

9. A computer-implemented data display method being performed by at least one processor executing stored instructions to perform steps comprising:
estimating a photographing position pose of image data in a coordinate system of three-dimensional data;
detecting a position of a predetermined matter from the image data; and
displaying a position of the matter on diagram data in a superposed manner, based on the photographing position pose and the position of the predetermined matter.

10. A non-transitory computer-readable storage medium storing a program for causing a computer to execute the computer-implemented data display method according to claim 9.
